(19) United States
(12) Patent Application Publication
(10) Pub. No.: US 2005/0080628 A1
(43) Pub. Date: Apr. 14, 2005

(54) System, method, and programming language for developing and running dialogs between a user and a virtual agent

(75) Inventor: Michael Kuperstein, Wellesley, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Metaphor Solutions, Inc.

(21) Appl. No.: 10/915,955

(22) Filed: Aug. 11, 2004

Related U.S. Application Data
(60) Provisional application No. 60/510,699, filed on Oct. 10, 2003.
(60) Provisional application No. 60/578,031, filed on Jun. 8, 2004.

(51) Int. Cl. G10L 11/00

(52) U.S. Cl. 704/270.1

(57) ABSTRACT

A speech dialog management system where each dialog is capable of supporting one or more turns of conversation between a user and virtual agent using any one or combination of a communications interface and data interface. The system includes a computer and a computer readable medium, operatively coupled to the computer, that stores scripts and dialog information. Each script determines the recognition, response, and flow control in a dialog while an application running on the computer delivers a result to any one or combination of the communications interface and data interface based on the dialog information and user input.

### RELATED APPLICATIONS

This application claims the benefit of U.S. Provisional Application No. 60/510,699, filed on Oct. 10, 2003 and U.S. Provisional Application No. 60/518,031, filed on Jun. 8, 2004. The entire teachings of the above referenced applications are incorporated herein by reference.

### BACKGROUND OF THE INVENTION

Initially, touch tone interactive voice response (IVR) had a major impact on the way business was done at call centers. It has significantly reduced call center costs and is automatically completing service calls at an average rate of about 50%. However, the caller experience of wading through multiple levels of menus and frustration of not getting to where the caller wants to go, has made this type of service the least favorite among consumers. Also, using the phone keypad is only useful for limited types of caller inputs.

After many years in development, a newer type of automation using speech recognition is finally ready for prime time at call centers. The business case for implementing automated speech response (ASR) has already been proved for call centers at such companies as United Airlines, FedEx, Thrifty Car Rental, Amtrak and Sprint PCS. These and many other companies are saving 30-50% of their total call center costs every year as compared to using all live service agents. The return on investment (ROI) for these cases is in the range of about 6-12 months, and the companies that are upgrading from touch tone IVR to ASR are getting an average rate of call completion of about 80% and savings of an additional 20-50% of the total costs over IVR.

Not only do these economics justify call centers to start adopting automated speech response, but there are other major benefits to using ASR that increase the quality of the service to consumers. These include zero hold times, reduction of frustrated callers, a homogeneous pleasant presentation to callers, quick accommodation to spikes in call volume, shorter call durations, much wider range of caller inputs over IVR, identity verification using voice and the ability to provide callers with additional optional purchases. In general ASR allows callers to get what they want easier and faster than touch tone IVR.

However, when technology buyers at call centers understand all the benefits and ROI of ASR and then try to implement an ASR solution themselves, they are often faced with sticker shock at the cost of developing and deploying a solution.

The large costs are in developing and deploying the actual software that automates the service script itself. Depending on the complexity of the script, dialog and back-end integration, costs can run anywhere from $200,000 to $2,500,000. At these prices, the only economic justification for deploying ASR solutions and getting a ROI in less than a year is for call centers that use from several hundred to several thousand live agents for each application. Examples of these applications include phone directory services and TV shopping network stations.

But what about the vast majority of the 80,000 call centers in the U.S. that are mid-sized and use 50-200 live agents per application? At these integration costs, the economic justification, for mid-sized call centers, falls apart and as a result they are not adopting ASR.

A large part of the integration costs are in developing customized ASR dialogs. The current industry standard interface languages for developing dialogs are Voice XML and SALT. Developing dialogs in these languages is very complex and lengthy, causing development to be very expensive. The reason they are complex include:

VoiceXML and SALT are based on XML syntax with a strong constraint on formal syntax that is easy for a computer to read but taxing on a person to manually develop in.

Voice XML is a declarative language and not a procedural one. However, speech dialog flows are procedural.

Voice XML and SALT were designed to mimic the “forms” object in the graphical user interfaces (GUI) of websites. As a result a dialog is implicitly defined as a series of forms where a prompt is like a form label and the user response is like a text input field. However, many dialogs are not easily structured as a series of forms because of conditional flows, evolving context and inferred knowledge.

There have been a number of recent patents related to speech dialog management. These include the following:

The patent entitled “Tracking initiative in collaborative dialogue interactions” (U.S. Pat. No. 5,999,904) discloses methods and apparatus for using a set of cues to track task and dialogue initiative in a collaborative dialogue. This patent requires training to improve the accuracy of an existing directed dialog management system. It does not reduce the cost of development, which is one of the major values of the present invention.

The patent entitled “Method and apparatus for executing a human-machine dialogue in the form of two-sided speech as based on a modular dialogue structure” (U.S. Pat. No. 6,035,275) discloses methods for developing a speech dialog through the use of a hierarchy of subdialogs called High Level Dialogue Definition language (HLDD) modules. This is similar to “Speech Objects” by Nuance. The patent also discloses the use of alternative subdialogs that are used if the primary subdialog does not result in a successful recognition of the person's response. This approach does reduce the development time of speech dialogs with the use of pre-tested, re-usable subdialogs, but lacks the necessary flexibility, context dependency, ease of implementation, interface to industry standard protocols and external data source integration that would result in a significant quantum reduction of the cost of development.

The patent entitled “Methods and apparatus object-oriented rule-based dialogue management” (U.S. Pat. No. 6,044,347) discloses a dialogue manager that processes a set of frames characterizing a subject of the dialogue, where each frame includes one or more properties that describe an object which may be referenced during the dialogue. A weight is assigned to each of the properties represented by the set of frames, such that the assigned weights indicate the relative importance of the corresponding properties. The dialogue manager utilizes the weights to determine which of a number of possible responses the system should generate based on a given user input received during the dialogue. The dialogue manager serves as an interface between the user and an application which is running on the system and defines the set of frames. The dialogue manager supplies user requests to the application, and processes the resulting responses received from the application. The dialogue manager uses the property weights to determine, for example, an appropriate question to ask the user in order to resolve ambiguities that may arise in execution of a user request in the application.

Although this patent discloses a flexible dialog manager that deals with ambiguities, it does not focus on fast and easy development, since it does not deal well with the following: organizing speech grammars and audio files are not efficient; manually determining the relative weights for all the frames requires much skill, creating a means of asking the caller questions to resolve ambiguities requires much effort. It does not deal well with interfaces to industry standard protocols and external data source integration.

The patent entitled “System and method for developing interactive speech applications” (U.S. Pat. No. 6,173,266) is directed to the use of re-usable dialog modules that are configured together to quickly create speech applications. The specific instance of the dialog module is determined by a set of parameters. This approach does impact the speed of development but lacks flexibility. A customer cannot easily change the parameter set of the dialog modules. Also the dialog modules work within the syntax of a standard application interface like Voice XML, which is still part of the problem of difficult development. In addition, dialog modules, by themselves do not address the difficulty of implementing complex conditional flow control inherent in good voice-user-interfaces, nor the difficulty of integration of external web services and data sources into the dialog.

The patent entitled “Natural language task-oriented dialog manager and method” (U.S. Pat. No. 6,246,981) discloses the use of a dialog manager that is controllable through a backend and a script for determining a behavior for the dialog manager. The recognizer may include a speech recognizer for recognizing speech and outputting recognized text. The recognized text is output to a natural language understanding module for interpreting natural language supplied through the input. The synthesizer may be a text to speech synthesizer. The task-oriented forms may each correspond to a different task in the application, each form including a plurality of fields for receiving data supplied by a user at the input, the fields corresponding to information applicable to the application associated with the form. The task-oriented form may be selected by scoring the forms relative to each other according to information needed to complete each form and the context of information input from a user. The dialog manager may include means for formulating questions for one of prompting a user for needed information and clarifying information supplier by the user. The dialog manager may include means for confirming information supplied by the user. The dialog manager may include means for inheriting information previously supplied in a different context for use in a present form.

This patent views a dialog as filling in a set of forms. The forms are declarative structures of the type “if the meaning of the user's text matches a specified subject then do the following”. The dialog manager in this patent allows some level of semantic flexibility, but does not address the development difficulty in real world applications for the difficulty in creating the semantic parsing that gives the flexibility, organizing speech grammars and audio files; interacting with industry standard speech interfaces, nor the difficulty of integration of external web services and data sources into the dialog.

The patent entitled “Method and apparatus for discourse management” (U.S. Pat. No. 6,356,869) discloses a method and an apparatus for performing discourse management. In particular, the patent discloses a discourse management apparatus for assisting a user to achieve a certain task. The discourse management apparatus receives information data elements from the user, such as spoken utterances or typed text, and processes them by implementing a finite state machine. The finite state machine evolves according to the context of the information provided by the user in order to reach a certain state where a signal can be output having a practical utility in achieving the task desired by the user. The context based approach allows the discourse management apparatus to keep track of the conversation state without the undue complexity of prior art discourse management systems.

Although this patent teaches about a flexible dialog manager that deals well with evolving dialog context, it does not focus on fast and easy development, since it does not deal well with the following: the difficulty in creating the semantic parsing that gives the flexibility; organizing speech grammars and audio files are not efficient; interacting with industry standard speech interfaces; and low level exception handling.

The patent entitled “Scalable low resource dialog manager” (U.S. Pat. No. 6,513,009) discloses an architecture for a spoken language dialog manager which can, with minimum resource requirements, support a conversational, task-oriented spoken dialog between one or more software applications and an application user. Further, the patent discloses that architecture as an easily portable and easily scalable architecture. The approach supports the easy addition of new capabilities and behavioral complexity to the basic dialog management services.

As such, one significant distinction from other approaches is found in the small size of the dialog management system. The dialog manager in this patent uses the decoded output of a speech grammar to search the user interface data set for a corresponding spoken language interface element and data which is returned to the dialog manager when found. The dialog manager provides the spoken language interface element associated data to the application or system for processing in accordance therewith.

This patent is a simpler form of U.S. Pat. No. 6,246,981 discussed above and is focused on use with embedded devices. It is too rigid and too simplistic to be useful in many customer service applications where flexibility is required.

The ASR industry is aware of the complexity of using Voice XAL and SALT and a number of software tools have been created to make dialog development with ASR much easier. One of the better known tools is being sold by a company called Audium. This is a development environment that incorporates flow diagrams for dialogs, similar to the Microsoft product VISIO, with drag-and-drop graphical elements representing parts of the dialog. The Audium product represents a flow diagram style that most of the newer tools use.

Each graphical element in the flow diagram has a property sheet that the developer fills out. Although this tool improves the productivity of dialog developers by about a factor of about 3 over developing straight from Voice XML and SALT, there are a number of remaining issues with a totally graphical approach to dialog development:

Real world dialogs often have conditional flows and nested conditionals and loops. These occupy very large spaces in graphical tools making it confusing to follow.

A lot of the development work for real world dialogs is exception handling, which still have to be thoroughly programmed. Also, these additional conditionals add graphical confusion for the developer to follow.

In general, flow diagrams are useful for simple flows with few conditionals. Real world ASR dialogs, especially long ones, have many conditionals, confirmation loops, exception handling and multi-nested dialog loops that are still difficult to develop using flow diagrams. More importantly, most of the low level process and structure that is manually programmed with VoiceXML and SALT still need to be explicitly entered into the flow diagram.

### SUMMARY OF THE INVENTION

The present invention provides an optimal combination of speed of development with flexibility of flow control and interfaces for commercial speech dialogs and applications. Dialogs are viewed as procedural processes that are mostly easily managed by procedural programming languages. The best examples of managing procedural processes having a high level of conditional flow control are standard programming languages like C++, Basic, Java and JavaScript. After more than 30 years of use, these languages have been honed to optimal use. The present invention leverages the best features of these languages applied to real world automated speech response dialogs.

The present invention also represents a dialog as not just a sequence of forms. A dialog may also include flow control, context management, call management, dynamic speech grammar generation, communication with service agents, data transaction management (e.g., database and web services) and fulfillment management which are either very difficult or not possible to program into current, standard voice interfaces such as Voice XML and SALT scripts. The invention provides for integration of these functions into scripts.

The invention adapts features of standard procedural languages, dynamic web services and standard integrated development environments (IDEs), toward developing and running automated speech response dialogs. A procedural software language or script language is provided, called MetaphorScript.

This high level language is designed to develop and run dialogs which share knowledge between a person and a virtual agent for the purpose of solving a problem or completing a transaction. This language provides inherited resources that automate much of what speech application developers program manually with existing low-level speech interfaces as well as allow dynamic creation of dialogs from a service script depending on the dialog context. The inherited speech dialog resources may include, for example, speech interface software drivers, automated dialog exception handling, organization of grammar and audio files to allow easy authoring and integration of grammar results with dialog variables. The automated dialog exception handling may include handling the event when a user says nothing and times out and the event when the received speech is not known in a given speech grammar. The language also allows proven applications to be linked as reusable building blocks with new applications, further leveraging development efforts.

There are three major components of a system for developing and running dialog sessions: editor, linker and run-time interpreter.

The editor allows the developer to develop an ASR dialog by entering text scripts in the script language syntax, which is similar to JavaScript. These scripts determine the flow control of a dialog. In addition the editor allows the developer to enter information in a tree of property sheets associated with the scripts to determine dialog prompts, audio files, speech grammars, external interfaces and script language variables. It saves all the information about an application in an XML project file. The defined project enables, builds and runs an application.

The linker reads the XML project file and checks the consistency of the scripts and associated properties, reports errors if any, and sets up the implementation of the run-time environment for the application project.

The run-time interpreter reads the XML project file and responds to a user through either a voice gateway using speech or through an Internet browser using HTML text exchanges, both of which are derived from the scripts, internal and external data sources and associated properties. The HTML text dialog with users does not have any of the input grammars that a voice dialog has, since the input is just what the users type in, while the voice dialog requires a grammar to transcribe what the users say to text. In embodiments of the present invention, the text dialog mode may be used to simulate a speech dialog for debugging the flow of scripts. However, in other embodiments, the text dialog may be the basis for a virtual chat solution in the market.

One embodiment of the present invention includes a method and system for developing and running speech dialogs where each dialog is capable of supporting one or more turns of conversation between a user and virtual agent via a communications interface or data interface. A communications interface typically interacts with a person while a data interface interacts with a computer, machine, software application, or other type of non-person user. The system may include an editor for defining scripts and entering dialog information into a project file. Each script typically determines the flow control of one or more dialogs while each project file is typically associated with a particular dialog. Also, a linker may use a project configuration in the project file to set up the implementation of a run-time environment for an associated dialog. Furthermore, an computer application such as the Conversation Manager program, that may include a run-time interpreter, typically delivers a result to either or both a communications interface and data interface based on the dialog information in the project file and user input.

Based on the result, the communications interface preferably delivers a message to the user such as a person. The data interface may deliver a message to a non-person user as well. The message may be a response to a user query or may initiate a response from a user. The communications interface may be any one or combination of a voice gateway, Web server, electronic mail server, instant messaging server (IMS), multimedia messaging server (MMS), or virtual chat system.

In this embodiment, the application and voice gateway preferably exchange information using either the VoiceXML or SALT interface language. Furthermore, the result is typically in the form of VoiceXML scripts within an ASP file where the VoiceXML references either or both speech grammar and audio files. Thus, the voice gateway message may be in the form of playing audio for the user derived from the speech grammar and audio files. The message, however, may be in various forms including text, HTML text, audio, an electronic mail message, an instant message, a multimedia message, or graphical image.

The user input may also be the form of text, HTML text, speech, an electronic mail message, an instant message, a multimedia message, or graphical image. When the user input is in the form of speech from a caller user, the user speech is typically converted by the communications interface into user input text using any standard speech recognition technique, and then delivered to the application which includes in interpreter.

The dialog information typically includes either or a combination of dialog prompts, audio files, speech grammars, external interface references, one or more scripts, and script variables. The application may perform interpretation on a statement by statement basis where each statement resides within the project file.

The editor preferably defines scripts using a unique script language. The script language typically includes any one or combination of literals, integers, floating-point literals, Boolean literals, dialog variables, internal dialog variables, arrays, operators, functions, if/then statements, switch/case statements, loops, for loops, while loops, do/while loops, dialog statements, external interfaces statements, and special statements. The editor also preferably includes a graphical user interface (GUI) that allows a developer to perform any one of file navigation, project navigation, script text editing, property sheet editing, and linker reporting. The linker may create the files, interfaces, and internal databases required by the interpreter of the speech dialog application.

The application typically uses an interpreter to parse and interpret script statements and associated properties in a script plan where each statement includes any one of dialog, flow control, external scripts, internal state change, references to external context information, and an exit statement. The interpreter's result may also be based on any one or combination of external sources including external databases, web services, web pages through web servers, electronic mail servers, fax servers, CTI interfaces, Internet socket connections, and other dialog session applications. Yet further, the interpreter result may be based on a session state that determines where in a script to process a dialog session next. The interpreter also preferably saves the session state after returning the result to either or both the communications interface and data interface.

Another embodiment of the present invention includes a speech dialog management system and method where each dialog supports one or more turns of conversation between a user and virtual agent using a communications interface or data interface. In this embodiment, an editor and linker are not necessarily present. The dialog management system preferably includes a computer and computer readable medium, operatively coupled to the computer, that stores text scripts and dialog information.

Each text script then determines the recognition, response, and flow control of a dialog while an application, based on the dialog information and user input, delivers a result to either or both the communications interface and data interface.

### BRIEF DESCRIPTION OF THE DRAWINGS

FIG. 1 shows a speech dialog processing system in accordance with the principles of the present invention.

FIG. 2 shows a process flow according to principles of the present invention.

FIG. 3 shows an alternative embodiment of the dialog session processing system.

FIG. 4 is a top-level view of a graphical user interface (GUI) for a conversation manager editor with a linker tool encircled in the toolbar.

FIG. 5 is a detailed view of a section of the GUI of FIG. 4 corresponding to a file navigation tree function.

FIG. 6 is a detailed view of a section of the GUI of FIG. 4 corresponding to a project navigation tree function.

FIG. 7 is a detailed view of a section of the GUI of FIG. 4 corresponding to a script editor.

FIG. 8 is a detailed view of a section of the GUI of FIG. 4 corresponding to a dialog property sheet editor.

FIG. 9 is a detailed view of a section of the GUI of FIG. 4 corresponding to a dialog variable property sheet editor.

FIG. 10 is a detailed view of a section of the GUI of FIG. 4 corresponding to a recognition property sheet editor.

FIG. 11 is a detailed view of a section of the GUI of FIG. 4 corresponding to an interface property sheet editor.

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

### DETAILED DESCRIPTION OF THE INVENTION

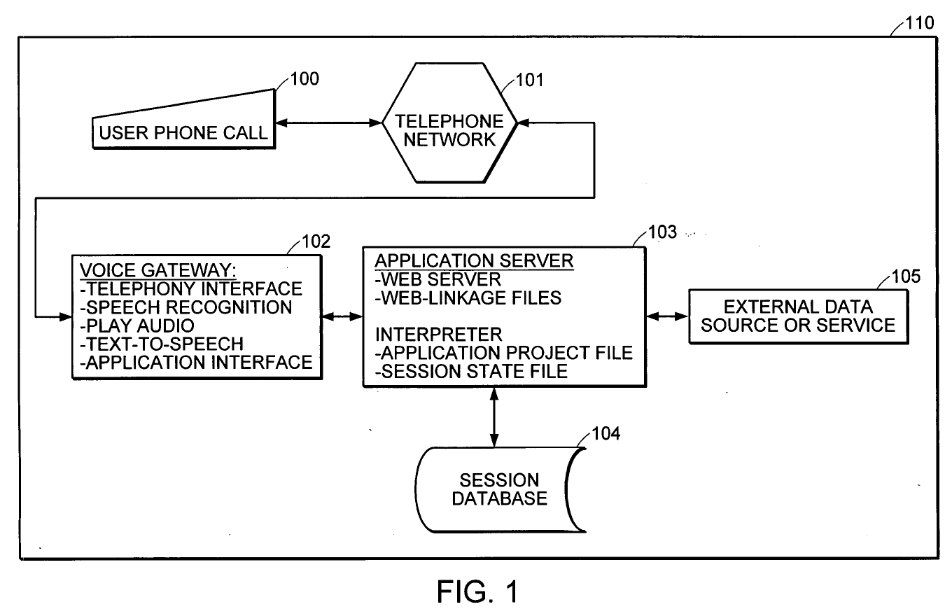

The present approach provides a method, system and unique script language for developing and running automated speech recognition dialogs using a dialog scripting language. FIG. 1 illustrates an embodiment of a speech dialog processing system 110 that includes communications interface 102, i.e., a voice gateway, and application server 103. A telephone network 101 connects telephone user 100 to the voice gateway 102. In certain embodiments, communications interface 102 provides capabilities that include telephony interfaces, speech recognition, audio playback, text-to-speech processing, and application interfaces. The application server 103 may also interface with external data sources or services 105.

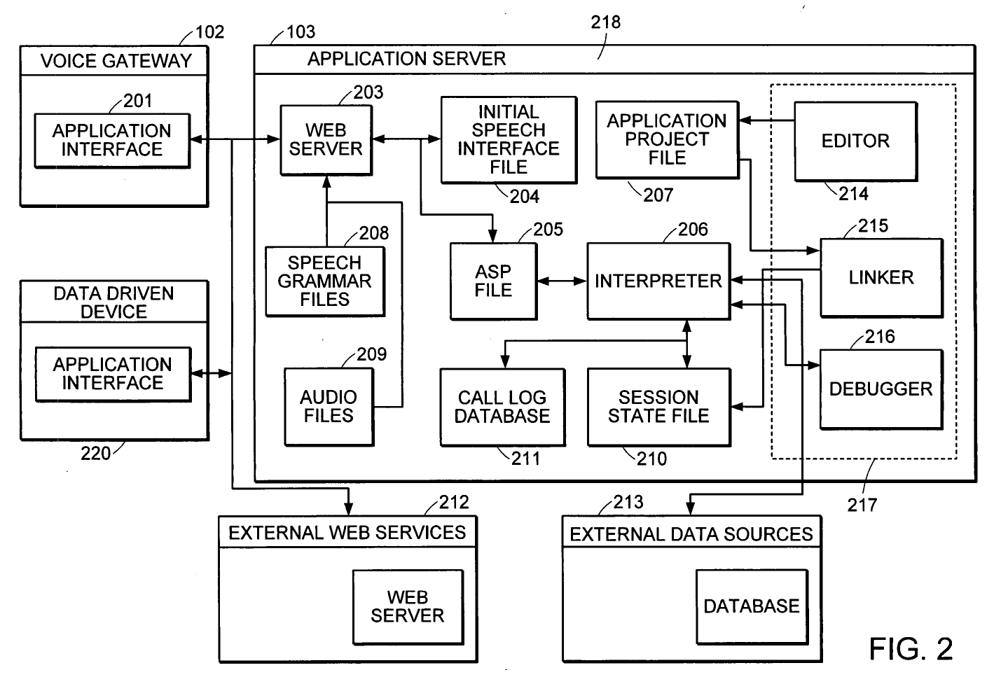

As shown in FIG. 2, application server 103 includes a web server 203, web-linkage files such as Initial Speech Interface file 204 and ASP file 205, a dialog session manager Interpreter 206, application project files 207, session state files 210, Speech Grammar files 208, Audio files 209 and Call Log database 211, the combination of which is typically referred to as dialog session speech application 218. Development of a dialog session speech application 218 may be performed in an integrated development environment using IDE GUI 217 which includes editor 214, linker 215 and debugger 216. A session database 104 and external data sources 213 or services 105 are also connected to application server 103. A data driven device interface 220 may be used to facilitate a dialog with a data driven device. Web server 212 may enable back-end data transactions over the web. Operation of these elements of the speech dialog processing system 110 is described in further detail herein.

The unique script language is a dialog scripting language which is based on a specification subset of JavaScript but adds special functions focused on speech dialogs. Scripts written in the script language are written directly into project files 207 to allow Interpreter 206 to dynamically generate dialogs at run time. The scripts, viewed as plans to achieve goals, are a sequence of functions, assignments of script variable expressions, logical operations, dialog interfaces and data interfaces (back end processing) as well as internal states. A plan is a set of procedural steps that implements a process flow with a user, data sources and/or a live agent that may include conditional branches and loops. A dialog interface specifies a single turn of conversation between a virtual agent and a user, i.e., person, whereby the virtual agent says something to a user and the virtual agent listens to recognize a response (or message) from the user. The user's response is recognized using speech grammars 208 that may include standard grammars as specified by the World Wide Web (WWW) Consortium that define expected utterances.

Script interpretation is done on a statement by statement basis. Each statement can only be on one line, except when there is a continuation character at the end of a line. Unlike JavaScript, there are no “;” characters at the end of each line.

A script may be called in two ways: The first script that is called in the beginning of any dialog is the one labeled as “start”. Every project typically has a “start” script. The other way a script is called is through a function called in one script which may refer to a function defined in another script, even across speech applications.

Elements of the script language may include:

Literals—are used to represent values in the script language. These are fixed values, not variables in the script. Examples of literals include: 1234, “This is a literal”, true.

Integers—are expressed in decimal. A decimal integer literal typically comprises of a sequence of digits without a leading 0 (zero) but can optionally have a leading ‘−’. Examples of integer literals are: 42, −345.

Floating-point literals—may have the following parts: a minus sign (“−”), a decimal integer, a decimal point (“.”) and a fraction (another decimal number). A floating-point literal must have at least one digit. Some examples of floating-point literals are 3.1415, −3123.

Boolean literals—have the values: true, false, 1, 0, “yes” and “no”.

String literals—A string literal is zero or more characters enclosed in double (“) quotation marks. A string is typically delimited by quotation marks. The following are examples of string literals: “blah”, “1234”.

Dialog Variables—hold values of various types used in the following ways:
To store the interpretations of what the user said
To store the input and output values of data interfaces through external COM objects or JAVA programs
To store internal states like the time of day
To store the input and output values for database interface
To store dynamic grammars
To store audio file names to be played or recorded.

All dialog variables preferably have unique names within a speech application. They usually have global scope throughout each application, so they are available anywhere in each application. They are named in lower case, starting with a letter, without spaces and can contain alphanumeric characters (0-9, a-z) and ‘_’ in any order, except for the first character. Capital letters (A-Z) are allowed but not advised except for obvious abbreviations. Dialog variables cannot be the same as any of the script keywords or special functions.

Dialog variables are typically case sensitive. That means that “My_variable” and “my_variable” are two different names to script language, because they have different capitalization. Some examples of legal names are: number_of hits, temp99, and read_RDF.

Dialog variables from other linked applications may be referenced by preceding the variable name with the name of the application with “::” in between. For example, to refer to a dialog variable named “street” in the application named “address”, use “address::street”. The linked application is typically listed in the project configuration. To assign a value to a variable, the following example notation may be used:
dividend=8
divisor=4.0
my_string=“I may want to use this message multiple times”
message=my_string
boolean_variable=“yes”
boolean_variable=1
street=address::street
address::street=street_name.

Consider the scenario where the main part of the function is dividing the dividend by the divisor and storing that number in a variable called quotient. A line of code may be written in the program: quotient=divisor/dividend. After executing the program, the value of quotient will be 2.

To clear a string dialog variable, the developer may either assign the special function clear or assign it to a blank literal. For example:
clear street
street=“ ”.

The script language preferably recognizes the following types of values: string, integer, float, boolean, or nbest (described below). Examples include: numbers, such as 42 or 3.14159; logical (Boolean) values, either true or false, 1 or 0; strings, such as “Howdy!”; null, a special keyword which refers to a value of nothing; second highest recognition choice such as spelling.

For string type dialog variables, the variables may also store the associated audio file path. This storage may be accessed by using “.audio” with the variable name such as goodbye.audio=“goodbye.wav”.

To prevent confusion when a dialog session program or application is written, the script language typically does not allow the data value type of dialog variables to be changed during run time. However, data values between boolean and integer may be converted in assignment statements.

In expressions involving numeric, boolean and string values, the script language typically converts the values to the most appropriate type. For example, if the answer is a boolean value type, the following three statements are equivalent:
answer=1
answer=true
answer=“yes”.

Internal Dialog Variables
abort_dialog (string)—the prompt and audio file that is played after the third and last time that the active speech grammar did not recognize what the user said. At this point the dialog gives up trying to understand the user.
abort_dialog_phone_transfer (string)—the phone number to transfer the user to either get a live person to more automated help elsewhere, after the dialog gives up trying to understand the user.
afternoon (boolean)—between the hours of 12 PM to 7 PM: 1, otherwise: 0
barge_in (boolean)—enable barge in. Default is on.
caller_name (string)—caller ID name if any
caller_phone (string)—the phone number of the caller
current_date (string)—current date in full format
current_day (string)—current day of the week
current_hour (string)—current hour in 12 hour format with AM/PM
current_month (string)—fill name of current month
current_year (string)—current year
data_interface_return (string)—the return value from any data interface call. This is used for error handling.
evening (boolean)—between the hours of 7 PM to 12 PM: 1, otherwise: 0
morning (boolean)—between the hours of 12 AM to 12 PM: 1, otherwise: 0
n_no_grammar_matches (integer)—number of no grammar matches at current turn
n_no_user_inputs (integer)—number of no user inputs cycles at current turn
no_recognition (string)—the prompt and audio file that is played after the first and second time that the current speech grammar did not recognize what the user said.
no_user_input (string)—the prompt and audio file that is played if the user did not speak above the current volume threshold within the current time out period after the last prompt was played. The time out period is about 4 seconds.
previous_subject (string)—previous subject if any
previous_user_input (string)—previous user input
session_id (string)—unique ID for the current dialog session
subject (string)—current subject if any
top_recognition_confidence (float)—top recognition confidence score for the current user input. The score measures how confident the speech recognizer is that the result matches what was actually spoken.

NBest Arrays—Most of the time a script plan gets some knowledge from the user with only one top choice such as yes/no or a phone number. However, at times, the script may require knowledge from the user that could be ambiguous such as spelling letters. For example “m” and “n” and “b” and “d” are probably difficult to distinguish. By giving a dialog variable a value type of nbest, it will store a maximum of the top 5 choices that may be recognized by the speech grammar. The values are always strings. To access one of the choices, the following syntax may be used: <nbest_variable>.<i> where <i> is either an integer or a dialog variable with a value ranging from 0 to 4. The 0 choice is the top choice. An example of using an nbest variable to access the third best choice is: letter=spelling.2. This is the same as if the integer variable count has a value of 2 in the next example: letter=spelling.count.

Operators
Assignment Operators—An assignment operator assigns a value to its left operand based on the value of its right operand. The basic assignment operator is equal (=), which assigns the value of its right operand to its left operand. Note that the = sign here refers to assignment, not “equals” in the mathematical sense. So if x is 5 and y is 7, x=x+y is not a valid mathematical expression, but it is valid in script language. It makes x the value of x+y (12 in this case). For an assignment the allowed operations are “+”, “−”, “*”, “/” and “%” and the logical operators below. The “+” operator can be applied to integers, floats and strings. For strings, the “+” operator does a concatenation. The “%” can only be applied to integers. A developer may also assign a boolean expression using the “&&” and “∥”. For example, the boolean variable answer can be assigned a logical operation on 3 boolean variables: answer=(condition1 && condition2)∥condition3
Comparison Operators—A comparison operator compares its operands and returns a logical value based on whether the comparison is true or false. The operands may be numerical or string values. When used on string values, the comparisons are based on the standard lexicographical ordering. They are described in the following:
   Equal (==) evaluates to true if the operands are equal. x==y evaluates to true if x equals y.
   Not equal (!=) evaluates to true if the operands are not equal. x!=y evaluates to true if x is not equal to y.
   Greater than (>) evaluates to true if left operand is greater than right operand. x>y evaluates to true if x is greater than y.
   Greater than or equal (>=) evaluates to true if left operand is greater than or equal to right operand. x>=y evaluates to true if x is greater than or equal to y.
   Less than (<) evaluates to true if left operand is less than right operand. x<y evaluates to true if x is less than y.
   Less than or equal (<=) evaluates to true if left operand is less than or equal to right operand. x<=y evaluates to true if x is less than or equal to y.
   Examples:
      5==5 would return TRUE.
      5 !=5 would return FALSE.
      5<=5 would return TRUE.
Arithmetic Operators—Arithmetic operators take numerical values (either literals or variables) as their operands and return a single numerical value. The standard arithmetic operators are addition (+), subtraction (−), multiplication (*), division (/) and remainder (%). These operators work as they do in other programming languages, as well as in standard arithmetic.
Logical Operators—Logical operators take Boolean (logical) values as operands and return a Boolean value. That is, they evaluate whether each subexpression within a Boolean expression is true or false, and then execute the operation on the respective truth values. The operators include: and (&&), or (∥), not (!).

Functions—are one of the fundamental building blocks in the present script language. A function is a script procedure or a set of statements. A function definition has these basic parts: The keyword “function”, a function name, and a parameter list, if any, between two parentheses. parameters are separated with commas. The statements in the function are inside curly braces: “{ }”.

Defining the function gives the function a name and specifies what to do when the function is called. In defining a function, the variables that will be called in that function must be declared. The following is an example of defining a function:

function alert( ) {
tell_alert
}

Parentheses are included, even if there are no parameters. Because all dialog variables have a unique name and have global scope there is no need to pass a parameter into the function.

Calling the function performs the specified actions. When you call a function, this is usually within the plan of the script, and can be in any script of the speech application. The following is an example of calling the same function:

alert( )

Functions can also be called in other linked applications and are typically referenced with a preceding application name with “::” in between. For example:

address::get_mailing_address( )

The linked application is typically listed in the configuration property sheet that is described further herein below. Function calls in linked applications may also pass dialog variables by value through a parameter list. For example:

address::get_street(city, state, zip_code, street)

All parameters are typically defined as dialog variables in both the calling application and the called application and all parameters are both input and output values. Even though the dialog variables have the same names across applications, they are treated as distinct and during the function call, all values are passed from the calling application to the called application and then when the function returns, all values are passed back. If a function is called local to an application, the parameter list is ignored, because all dialog variables have a scope throughout an application.

Functions may be called from any application to any other application, if all the linked applications are listed in the configuration property sheet of the starting application. For example, in the starting application, “app0”, app1::fun1(x,y) can be called and then in the “app1” application, app2::fun2(a,b) can be called.

If/Then—statements execute a set of commands if a specified condition is true. If the condition is false, another set of statements can be executed through the use of the else keyword. The syntax is:

```
if (condition) {
    statements1
}
if (condition) {
    statements1
}
else {
    statements2
}
```

An “if”statement does not require an else statement following it, but an else statement must be preceded by an if statement. The condition can be any script language expression that evaluates to true or false. Parentheses are typically required around the condition. If the condition evaluates to true, the statements in statements1 are executed. A condition may use any of the comparison or logical operators available.

Statements1 and statements2 can be any script language statements, including further nested if statements. All statements are preferably enclosed in braces, even if there is only one statement. For example:

```
if (morning) {
    tell_good_morning
}
else if(afternoon){
    tell_good_afternoon
}
else {
    tell_good_evening
}
```

Each statement with a “{” or “}” is typically on a separate line. So the syntax “} else {” is not allowed.

Switch/Case—statements allow choosing the execution of statements from a set of statements depending on matching a value of a specific case. The syntax is:

```
switch(<dialog variable>){
    case <literal value>:
    ..... (statements)
    break
}
```

An example of a switch/case set of statements is:

```
switch(count){
    case 0:
        letter = spelling.0
        break
    case 1:
        letter = spelling.1
        break
    case 2:
        letter = spelling.2
        break
    default:
        clear letter
        break
}
```

Loops—are useful for controlling dialog flow. Loops handle repetitive tasks extremely well, especially in the context of consecutive elements. Exception handling immediately springs to mind here, since most user inputs need to be checked for accuracy and looped if wrong. The two most common types of loops are for and while loops:

For Loops

A “for loop” constitutes a statement including three expressions, enclosed in parentheses and separated by semicolons, followed by a block of statements executed in the loop. A “for loop” resembles the following:

for (initial-expression; condition; increment-expression) {
statements
}

The initial-expression is an assignment statement. It is typically used to initialize a counter variable. The condition is evaluated both initially and on each pass through the loop. If this condition evaluates to true, the statements in statements are performed. When the condition evaluates to false, the execution of the “for” loop stops. The increment-expression is generally used to update or increment the counter variable. The statements constitute a block of statements that are executed as long as condition evaluates to true. This may be a single statement or multiple statements.

Although not required, it is good practice to indent these statements from the beginning of the “for” statement to make the program code more readable. Consider the following for statement that starts by initializing count to zero. It checks whether count is less than three, performs a user dialog statement to get digits, and increments count by one after each of the three passes through the loop:

for (count = 0; count < 3; count = count +1) {
get(4_digits_of_serial_number)
}

While Loops

The “while loop” is functionally similar to the “for's” statement. The two can fill in for one another—using either one is only a matter of convenience or preference according to context. The “while” creates a loop that evaluates an expression, and if it is true, executes a block of statements. The loop then repeats, as long as the specified condition is true. The syntax of while differs slightly from that of for:

while (condition) {
statements
}

The condition is evaluated before each pass through the loop. If this condition evaluates to true, the statements in the succeeding block are performed. When the condition evaluates to false, execution continues with the statement following the block. The block of statements are executed as long as the condition evaluates to true. Although not required, it is good practice to indent these statements from the beginning of the statement. The following while loop iterates as long as count is less than three:

```
count = 0
while (count < 3) {
    get(4_digits_of_serial_number)
    count = count + 1
}
```

Do/While Loops

The “do/while loop” is similar to the while loop except the condition is checked at the end of the loop instead of the beginning. The syntax of “do/while” is:

do {
statements
}while(condition)

Here is an example of the do/while loop:

```
do {
    get(transaction_info)
    get(is_transaction_ok)
}while(!is_transaction_ok)
```

Dialog Statements—provide a high level reference to preset processes of telling the caller something and then recognizing what he said. There are two dialog statement types:
get—gets a knowledge resource or concept from the user through a dialog interface and stores it in a dialog variable. The syntax is “get(<dialog_variable>)”. An example is: “get(number_of_shares)”
tell—tells the user something. The syntax is: “tell_*”. An example is: “tell_goodbye”.

Each dialog statement has properties that need to be filled. They include:
name—of the dialog.
subject—of the dialog for context processing purposes.
say—what the caller will hear from the computer. The syntax is an arbitrary combination of “<text>(<dialog variable>)”. An example is: “(company) today has a stock price of (price)”. This property provides for a powerful and flexible combination of static information (i.e., <text>) with highly variable information (i.e., <dialog variable>). The “say” value will be parsed by the Interpreter. Any parentheses containing a dialog variable will be processed so that the string and/or audio-file-path value stored in the dialog variables will be output to the voice gateway. Thus, in this example, the dialog variable (company) could result in text-to-speech of the value of “company” or playback of a recorded audio file associated with “company”. Any text segment which is between parentheses will be processed so that the associated audio file in the “say_audio_list” will be played through the voice gateway.
say_variable—dynamic version of “say” stored in a dialog variable.
say_audio_list—the list of audio files associated with “say” text segments in order. The first text segment in “say” is associated with the first audio file, etc.
say_random_audio—enable the audio files for “say” to be played at random. This is useful in mixing up a computer confirmation among “OK”, “got it” and “all right” which makes the computer sound less rigid.
say_help—what the caller will hear from the computer if it can not recognize what the caller said. This has the same syntax as “say”.
say_help_variable—dynamic version of “say_help” stored in a dialog variable
say_help_audio_list—the list of audio files associated with “say_help”
say_help_random_audio—enable the audio files for “say_help” to be played at random.
focus_recognition_list—list of speech grammars used to recognize what the caller says. This is not used by the “tell” statement. These speech grammars are either defined by the W3C standards body, known as SRGS (speech recognition grammar specification) or are a representation of Statistical Language Model speech recognition determined by a speech recognition engine manufacturer such as ScanSoft, Nuance or other providers.

External Interface Statements
interface—calls an external interface method or function. The syntax is: “interface(<interface>)”. An example is: “interface(get_stock_price)”
db_get—gets the value of a dialog variable from a database value in a data source by using SQL database statements in a variable or in a literal. An internal ODBC interface is used to execute this function. The syntax is: “db_get(<data source>,<dialog variable>,<SQL>)”. An example is “db_get(account_db,price,sql_Statement)”.
db_set—sets a database value in a data source from the value of a dialog variable by using SQL database statements. An internal ODBC interface is used to execute this function. The syntax is: “db_set(<data source>,<dialog variable>,<SQL>)”. An example is “db_set(account_db price,sql_statement)”.
db_sql—executes SQL database statements on a data source. An internal ODBC interface is used to execute this function. The syntax is: “db_sql(<data source>,<SQL>)”. An example is “db_sql (account_db sql_statement)”.

Special Statements
goto—jumps to another part of the script. The syntax is: “goto<label>”. An example is:
goto finish
. . .
finish:
<goto label>—marks the place for a goto to jump to. The syntax is: “<label>:”. An example is shown above.
clear—erases the contents of a dialog variable. The syntax is: “clear<dialog variable>”. An example is: “clear price”
transaction_done—signifies to the call analysis process, if enabled, that the call transaction is complete while the user is still on the phone. This is used for determining the success rate of the application for the customer and is required for all completed transactions that need to be recorded as complete. This does not hang-up or exit from the dialog. The syntax is: “transaction_done”.
record—records the audio of what the user said and stores the audio file name in a dialog variable. The file is located in <install_directory>\speech_apps\call_logs\<app_name>\user_recordings The syntax is: “record(<dialog_variable>)”. An example is: “record(welcome_message)”
call_transfer—transfers the call to another phone number through the value of the dialog variable. The syntax is: “call_transfer(<phone>)”. An example is: “call_transfer (operator_phone)”
transfer_dialog—transfers the dialog to another Metaphor dialog through the value of the dialog variable. The syntax is: “transfer_dialog(<dialog_variable>)”. An example is: “transfer_dialog(next_application)”
write_text_file—writes text into a text file on the local computer. Both the text reference and the file path can be either a literal string or a dialog variable. The syntax is: “write_text_file(<dialog_variable>, <file_path>)”. An example is: “write_text_file(info, file)”.
read_text_file—reads a text file on the local computer into a dialog variable. The file path can be either a literal string or a dialog variable. The syntax is: “read_text_file(<file_path>,<dialog_variable>)”. An example is: “read_text_file(file,info)”.
find_string—tries to find a sub-string within a string starting a specified position and either return the position of where the matching sub-string begins or −1 if the sub-string can not be found. The syntax is: “find_string(<in-string>,<sub-string>,<start>,<position>)”. An example is: “find_string(buffer,“abc”,start,position)”.
insert_string—inserts a sub-string into a string at a position in the string. The syntax is: “insert_string(<in-string>,<start>,<sub-string>)”. An example is: “insert_string(buffer,start,“abcd”)”.
replace_string—replaces one sub-string with another anywhere it appears. The syntax is: “replace_string(<in-string>,<search>,<replace>)”. An example is: “replace_string(buffer,“abc”, “def”)”.
erase_string—erases a sequence of a string starting at a beginning position for a specified length. The syntax is: “erase_string(<in-string>,<start>,<length>)”. An example is: “erase_string(buffer,start,length)”.
substring—gets a sub-string of a string starting at a position for a specified length. The syntax is: “substring(<in-string>,<start>,<length>,<sub-string>)”. An example is: “substring(name,0,3,part)”.
string_length—gets the length of a string. The syntax is: “string_length(<string>,<length>)”. An example is: “string_length(buffer,length)”.
return—returns from a function call. Not required if there is a sequential end to a function. The syntax is: “return”
exit—ends the dialog and hangs-up. Not required if there is a sequential end of a script. The syntax is: “exit”.

Linked Applications—Once a project has been developed and tested, it can be reused by other projects as a linked application. This allows projects to be written once and then used many times by many other projects. Dialog session applications are linked at run time as the Interpreter 206 runs through the scripts. Scripts in any linked application can call functions and access dialog variables in any other linked application.

To set up a linked application, the following steps may be used: In the main application, fill in the linked application configuration of the application project with a list of application names for the linked applications, one on each line of the text form. This allows the Interpreter 206 to create the cross reference mapping.

In each of the linked applications other than the main application, enable “is_linked_application” in the project configuration.

Functions and dialog variables are referenced in linked applications by preceding the function or variable with the linked application name and “::” in between. For example:

address::get_mailing_address( ) and address::street_name.

A reference to an application dialog variable can be done on either side of an assignment statement. In a typical development cycle for linked applications, the applications are testedas stand-alone applications and then when they are ready to be linked, the “is_linked_application” is enabled.

When using linked applications tied to multiple main applications, the developer needs to consider that the audio files referred in linked applications may not change. So if two main applications use different voice talent in their recordings and then both use the same linked application, there could be a sudden change of voice talent heard by the caller when the script transfers control between linked applications.

Commenting—Comments allow a developer to write notes within a program. They allow someone to subsequently browse the code and understand what the various functions do or what the variables represent. Comments also allow a person to understand the code even after a period of time has elapsed. In the script language, a developer may only write one-line comments. For a one line comment, one precedes their comment with “//”. This indicates that everything written on that line, after the “//”, is a comment and the program should disregard it. The following is an example of a comment:
// This is a single line comment.

A sample script which defines a plan to achieve the goal of resetting a caller's personal identification number (PIN) is as follows:

```
tell_introduction
//say greeting
if ( morning ){
  tell_good_morning
}
else if ( afternoon ){
    tell_good_afternoon
}
else if ( evening ){
    tell_good_evening
}
tell_welcome
// Get the account
get_account( )
while (account != “1234”) {
  tell_sorry_not_valid_account
  get(try_again_ok)
  if (try_again_ok) {
    get_account( )
  }
  else {
    end_script( )
  }
}
count = 0
do{
  if(count >2){
      transfer_dialog(abort_dialog_phone_transfer)
  }
  // Get answer to the smart question
  no_match_tmp = no_recognition
  no_recognition = sorry_not_correct
  get(smart_question_answer)
  no_recognition = no_match_tmp
  if(smart_question_answer!=“smith”){
    if(count <2){
      tell_not_valid
    }
  }
  count = count +1
}while(smart_question_answer!=“smith”)
// Success. Inform caller, and end dialog
transaction_done
tell_okay_sending_new_pin
// Thanks and Goodbye
end_script( )
function get_account ( ) {
  get(account)
  get(account_ok)
  while (!account_ok) {
    tell_sorry_lets_try_again
    get(account)
    get(account_ok)
  }
}
function end_script ( ) {
  tell_thanks
  tell_goodbye
  exit
}
```

The graphical user interface (GUI) 217 that allows a developer to easily and quickly enter information about the dialog session application project in a project file 207 that will be used to run a dialog session application 218. A preferred embodiment is a plugin to the open source, cross-platform Eclipse integrated development environment that extends the available resources of Eclipse to create the sections of the dialog session manager integrated development environment that is accessed using IDE GUI 217.

The editor 214 typically includes the following sections:

File navigation tree for file resources needed that include project files, audio files, grammar files, databases, image files, and examples.

Project navigation tree for single project resources that include configurations, scripts, interfaces, prompts, grammars, audio files and dialog variables.

Script text editor.

Property sheet editor for editing values for existing property tags.

Linker reporting of linker errors and status.

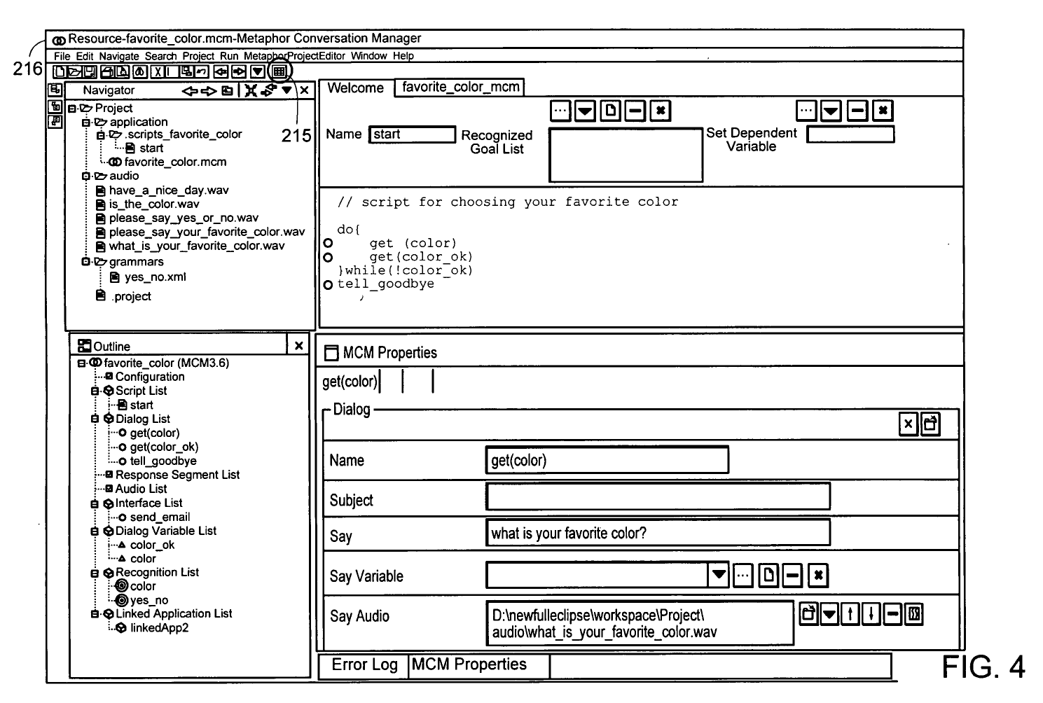

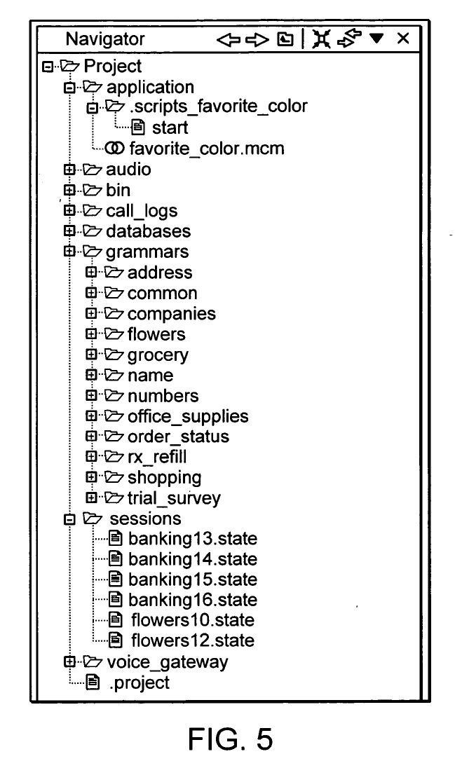

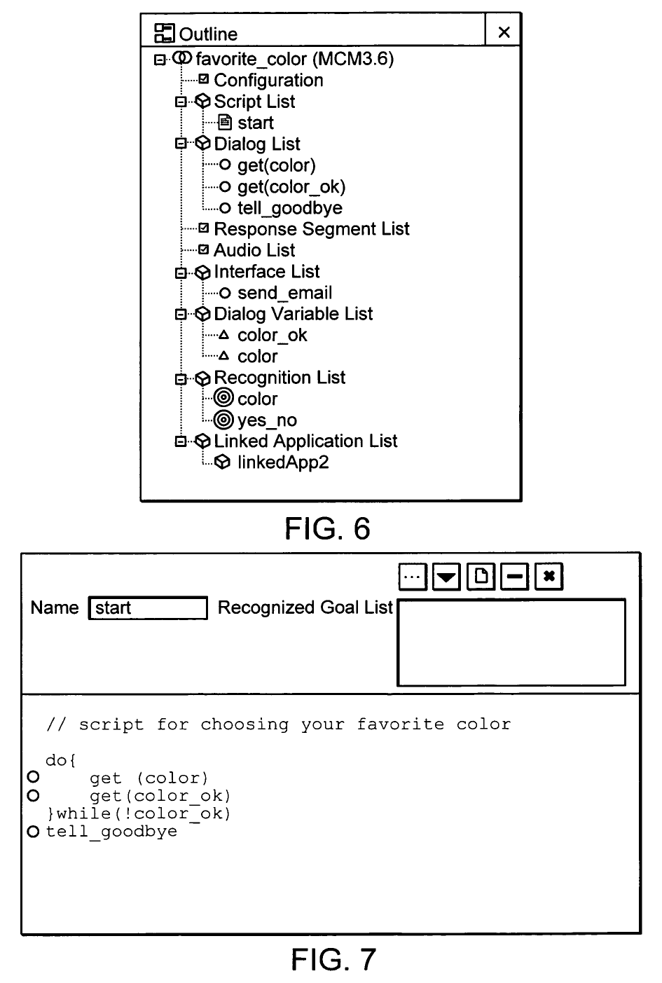

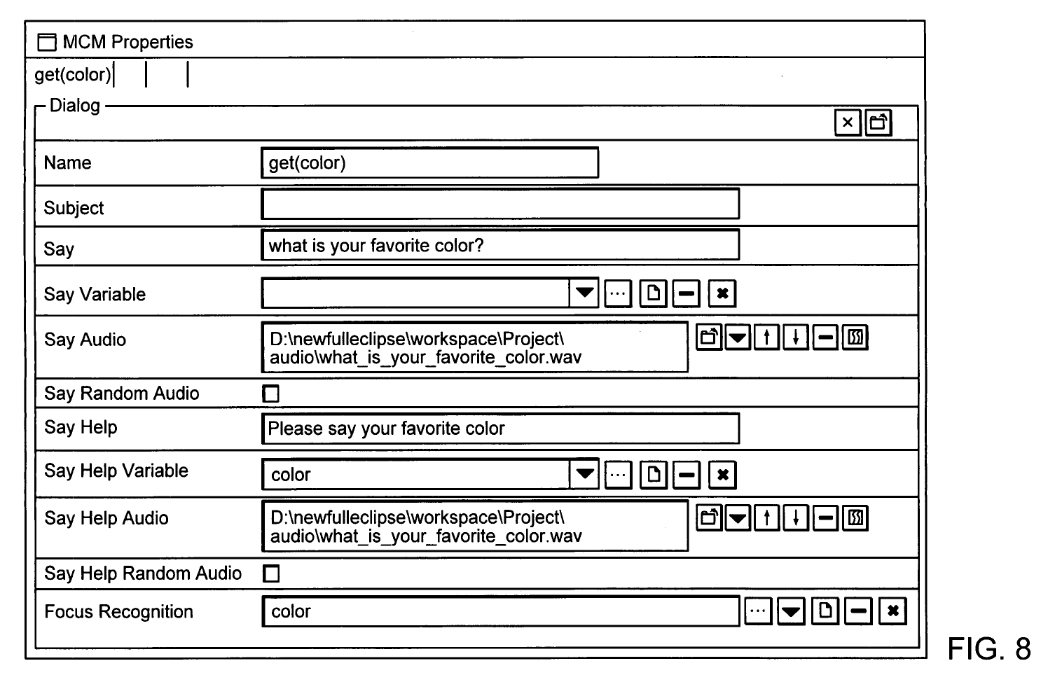

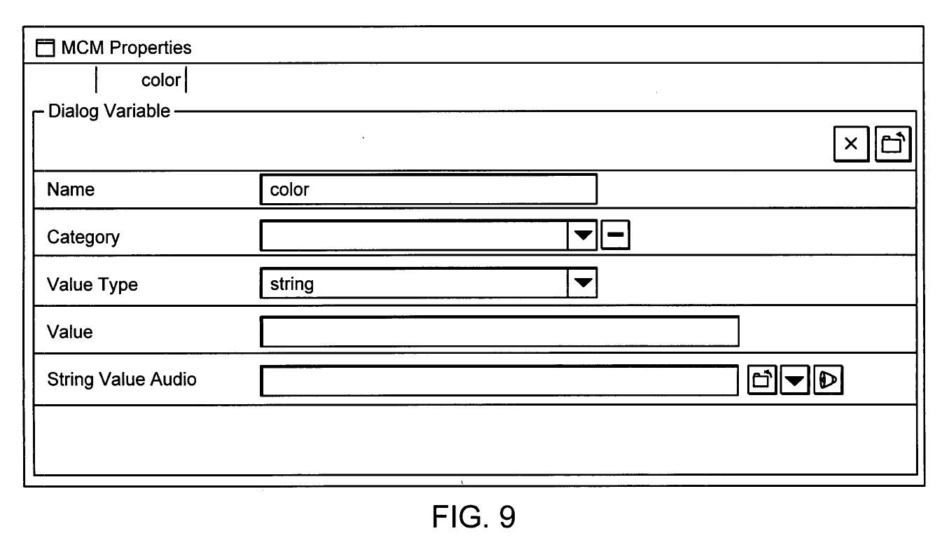

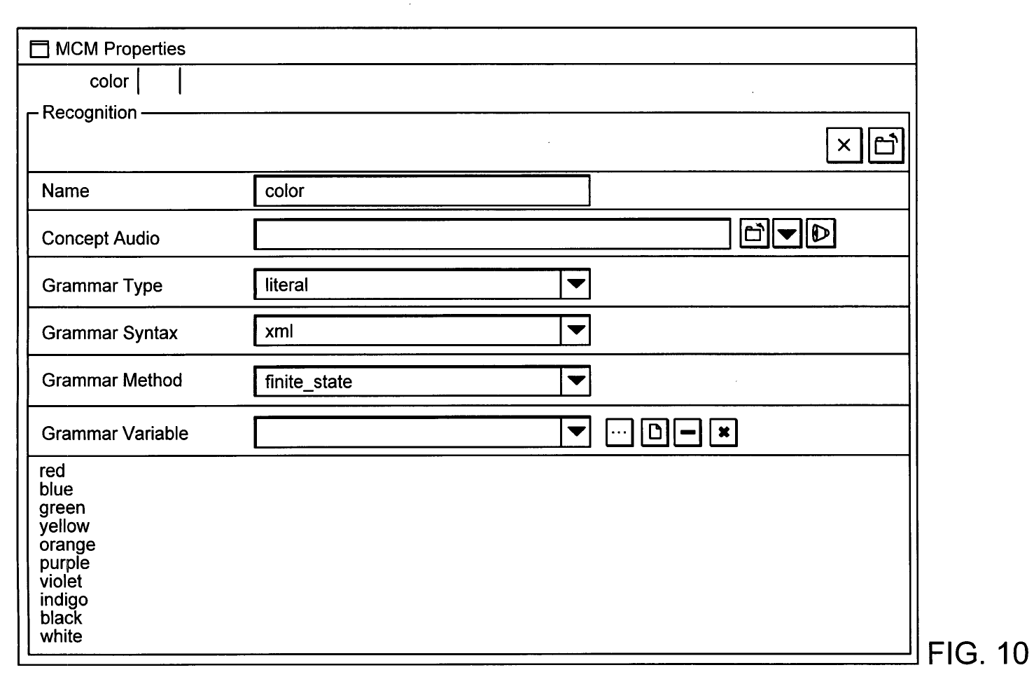

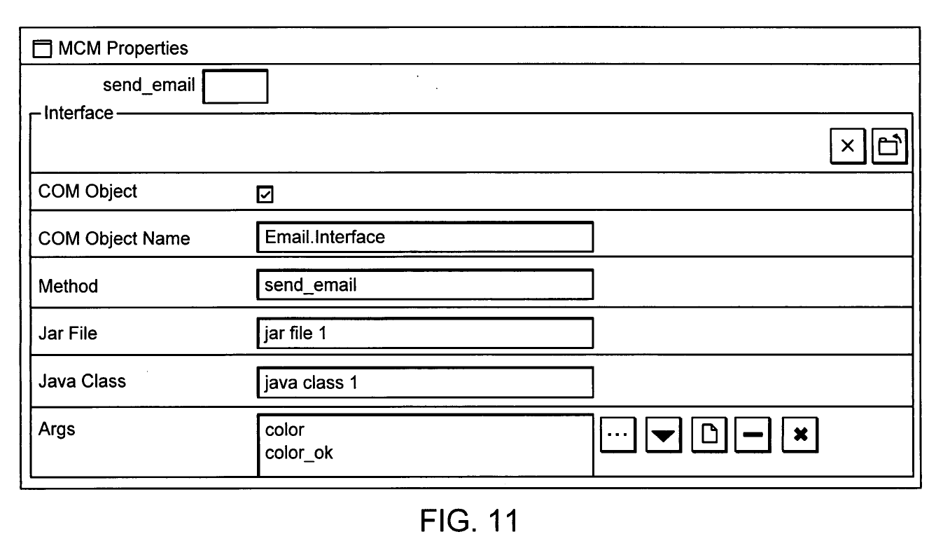

FIG. 4 provides a screen shot of the top-level view of the GUI which includes sections for the file navigation tree, project navigation tree, script editor, property sheet editor and linker 215 tool. FIGS. 5 through 11, respectively, provide more detailed views of these corresponding sections.

To organize project information for the run-time Interpreter 206, the editor 214 typically takes all the information that the developer enters into the GUI and saves it into the project file 207, i.e., an XML project file.

The schema of a typical project file 207 may be organized into the following XML file:

```
    <metaphor_project xmlns:xsi=“http://www.w3.org/2001/XMLSchema-instance”
xsi:noNamespaceSchemaLocation=“metaphor_project.xsd”>
        <version></version>
        <configuration>
            <application_name></application_name>
          <is_linked_application>false</is_linked_application> <!-- ,true (default: false)-
->
            <linked_application_list>
                <application_name></application_name>
            </linked_application_list>
            <init_interface_file></init_interface_file> <!-- <name>.vxml is the default
-->
            <phone_network>pstn</phone_network> <!-- ,sip,h323 (default: pstn) --
>
            <call_direction>incoming</call_direction> <!-- ,outgoing (default:
incoming) -->
            <speech_interface_type>vxml2</speech_interface_type><!--
,vxml1,salt1 (default: vxml2) -->
            <voice_gateway_server>voicegenie</voice_gateway_server> <!--
,envox,vocalocity,microsoft,nms,nuance,intel,ibm,cisco,genisys,i3, vocomo (default: voicegenie)
-->
            <voice_gateway_domain></voice_gateway_domain>
            <voice_gateway_ftp_username></voice_gateway_ftp_username>
            <voice_gateway_ftp_password></voice_gateway_ftp_password>
            <speech_recognition_type>scansoft</speech_recognition_type> <!--
,nuance,ibm,microsoft,att,bbn (default: scansoft) -->
            <tts_type>speechify</tts_type> <!-- ,rhetorical (default: speechify) -->
            <database_server>sql_server</database_server> <!-- , mysql, db2,
oracle (default mysql) -->
            <data_source_list>
              <data_source>
                <data_source_name></data_source_name>
                <username></username>
                <password></password>
              </data_source>
            </data_source_list>
            <enable_call_logs>false</enable_call_logs> <!-- (default false) -->
            <call_log_type>caller_audio</call_log_type> <!--
,prompt_audio,whole_call_audio (default: whole_call_audio) -->
            <enable_call_analysis>false</enable_call_analysis> <!-- (default: true)
-->
            <enable_billing>false</enable_billing> <!-- (default: false) -->
            <call_log_data_source_name></call_log_data_source_name> <!--
defaults to app name -->
            <call_log_database_username></call_log_database_username>
            <call_log_database_password></call_log_database_password>
            <interface_log>none</interface_log> <!-- ,increment, accumulate
(default: accumulate) -->
            <interface_admin_email></interface_admin_email> <!-- no default -->
            <enable_html_debug>true</enable_html_debug> <!-- defaults to true --
>
            <session_state_directory></session_state_directory> <!-- no default -->
        </configuration>
        <speech_application_list>
            <application>
                <name></name>
                <script_list>
                    <script>
                        <name></name>
                        <recognized_goal_list>
    <recognition_concept></recognition_concept>
                        </recognized_goal_list>
    <set_dependent_variable></set_dependent_variable>
                        <plan></plan>
                    </script>
                </script_list>
                <dialog_list>
                    <dialog>
                        <name></name>
                        <subject></subject>
                        <say></say>
                        <say_variable></say_variable>
                        <say_audio_list>
    <response_audio_file></response_audio_file>
                        </say_audio_list>
    <say_random_audio>true</say_random_audio>
                        <say_help></say_help>
                        <say_help_variable></say_help_variable>
                        <say_help_audio_list>
    <response_help_audio_file></response_help_audio_file>
                        </say_help_audio_list>
    <say_help_random_audio>true</say_help_random_audio>
                        <focus_recognition_list>
    <recognition_concept></recognition_concept>
                            </focus_recognition_list>
                    </dialog>
                </dialog_list>
                <interface_list>
                    <interface>
                        <type>COM</type> <!-- , Java (default: COM) -->
                            <com_object_name></com_object_name>
                            <com_method></com_method>
                            <jar_file></jar_file>
                            <java_class></java_class>
                            <argument_list>
                                <dialog_variable></dialog_variable>
                            </argument_list>
                    </interface>
                </interface_list>
                <recognition_list>
                    <recognition>
                            <concept></concept>
                            <concept_audio></concept_audio>
    <speech_grammar_type>slot</speech_grammar_type> <!-- ,literal,file,builtin -->
                <speech_grammar_syntax>srgs</speech_grammar_syntax>
<!-- ,gsl -->
    <speech_grammar_method>finite_state</speech_grammar_method> <!-- ,slm -->
                    <speech_grammar></speech_grammar>
<speech_grammar_variable></speech_grammar_variable>
                    </recognition>
                </recognition_list>
                <dialog_variable_list>
                    <dialog_variable>
                            <name></name>
                        <category>acronym</category> <!--
“measure”, “name”, “net”, “number”, “date:dmy”, “date:mdy”,
    “date:ymd”, “date:ym”, “date:my”, “date:md”, “date:y”, “date:m”,
    “date:d”, “time:hms”, “time:hm”, “time:h”, “duration”, “duration:hms”,
    “duration:hm”, “duration:ms”, “duration:h”, “duration:m”,
    “duration:s”, “number:digits”, “number:ordinal”, “cardinal”, “date”,
    “time”, “percent”, “pounds”, “shares”, “telephone”, “address”,
    “currency” -->
                        <value_type>string</value_type> <!--
,integer,float,boolean,nbest -->
                        <value></value>
                        <string_value_audio></string_value_audio>
                    </dialog_variable>
                </dialog_variable_list>
            </application>
        </speech_application_list>
    </metaphor_project>
```

The Linker 215, shown as a tool in FIG. 4, accomplishes the following tasks:

Checks the internal consistency of the entire dialog session project and reports any errors back to the dialog session manager. Its input is dialog session application project file 207.

Reports some statistics, measurements, descriptions and status of the implementation of the dialog session speech application. These include: size of the project, which internal databases and files were created and voice gateway interface information.

Creates all the files, interfaces and internal databases required to run the dialog session speech application. These files, all of which are specific to the application, include:
The ASP, JSP, PHP or ASP.NET file for application simulation via text only mode. These files generate HTML pages for viewing on a HTML browser.
Initial speech interface file 204 (FIG. 2) is a web-linkage file for the dialog session speech application that interfaces with communications interface 102, i.e., the voice gateway. This is either a Voice XML file or a SALT file. The voice gateway 102 maps an incoming call to the execution of this file and this file in turns starts the dialog session application by calling the following web-linkage file with an initial state and application identifiers.
The ASP, JSP, PHP or ASP.NET file 205 is a web-linkage file for dynamic generation of Voice XML or SALT. This file transfers the state and application information to the run-time Interpreter 206 and the multi-threaded Interpreter 206 returns the Voice XML or SALT that represents one turn of conversation. A turn of conversation between a virtual agent and a user is where the virtual agent says something to a user and the virtual agent listens to recognize a response message from the user.

Referring to FIG. 2, Linker 215 uses the project configuration in project file 207 to implement the run time environment. Since there can be a variety of platforms, protocols and interfaces used by the dialog session processing system 110 of FIG. 1, a specific combination of implementation files with specific parameters are setup to run across any of them. This allows a “write once, use anywhere” implementation. As new varieties are encountered, new files and parameters are added to the implementation linkage, without changing the speech application itself.

The project configuration specifies a configuration property sheet, defined using Editor 214 of FIG. 2, that includes the following parameters for a dialog session speech application:
application_name—name of the speech application.
is_linked_application—specifies whether the application is linked. The values are either “true” or “false”. Default is “false”.
linked_application_list—list of application names of linked applications that the active application refers to.
init_interface_file—the initial speech interface file called by the voice gateway 102. The voice gateway 102 maps a phone number to this file path.
phone_network—phone network encoding type such as PSTN, SIP or H323. The phone network 101 determines the method of implementing certain interfaces such as computer telephony integration (CTI).
call_direction—inbound or outbound.
speech_interface_type—an industry standard interface type and version of either VoiceXML or SALT.
voice_gateway_server—the manufacturer of the voice gateway 102.
voice_gateway_domain—domain URL used for retrieving files of recorded audio
voice_gateway_ftp_username—Username the FTP
voice_gateway_ftp_password—Password for the FTP
speech_recognition_type—manufacturer or the speech recognition engine software
text_to_speech_type—manufacturer of the text-to-speech engine software
database_server—manufacturer of the database server software
data_source_list—list of ODBC data sources, usernames and passwords used for external access to databases for values in the dialog
enable_call_logs—boolean for enabling call logging. The values are “true” or “false”. The default is “false”.
call_log_ype—Specifies the type of call log to generate. Values include “all”, “caller”, “prompts”, “whole_call”. The default is “all”
enable_call_analysis—boolean for enabling call analysis. The values are “true” or “false”. The default is “false”.
enable_billing—boolean for enabling call billing. The values are “true” or “false”. The default is “false”.
call_log_data_source_name—the data source name for the call log
call_log_database_username—the username for call_log_data_source_name
call_log database_password—the password for call_log_data_source_name
interface_log_type—type of logging on the literal output from the interpreter to the voice gateway. The values are “none”, “increment” or “accumulate”
interface_admin_email—used to report run time errors
enable_html_debug—boolean for enabling debug in simulation mode. The values are “true” or “false”. The default is “true”.
session_state_directory—used for flexible location of the session state file in a RAID database when scaling up the network of application servers.

The Interpreter 206 typically dynamically processes the dialog session speech application by combining the following information:

Application information from the initial speech interface web-linkage file 204 described above.

The application project file 207, which is used to initialize the application and all its resources.

State information on where in the script to process next, from the linkage file 204 described above.

Context information of the application and script accumulated from internal states and the previous segments of the conversation. The current context is stored on a hard drive between consecutive turns of conversation. An internal database stores the state information and the reference to the current context.

The current script statements to parse and interpret so that the next turn of conversation can be generated.

Referring again to FIG. 1, an overview of the interactions of the processes involved with the dialog session processing system 110 is described as follows:

The user 100 places a call to a dialog session speech application through a telephone network 101.

The call comes into a communications interface 102, i.e., the voice gateway. The voice gateway 102, which may be implemented using commercial voice gateway systems available from such vendors as VoiceGenie, Vocalocity, Genisys and others, has several internal processes that include:
Interfacing the phone call into data used internal to the voice gateway 102. Typical input protocols consists of incoming TDM encoded or SIP encoded signals coming from the call.
Speech recognition of the audio that the caller speaks into text strings to be processed by the application.
Audio playback of files to the caller.
Text-to-speech of text strings to the caller
Voice gateway interface to an application server in either Voice XML or SALT

The voice gateway 102 interfaces with application server 103 containing web server 203, application web-linkage files, Interpreter 206, application project file 207, and session state file 210 (FIG. 2). The interface processing between the voice gateway 102 and application server 103 loops for every turn of conversation throughout the entire dialog session speech application. Each speech application is typically defined by the application project file 207 for a certain dialog session. When Interpreter 206 completes the processing for each turn of conversation, the session state is stored in session state file 210 and the file reference is stored in a session database 104.

The Interpreter 206 processes one turn of conversation each time with information from the voice gateway 102, internal project files 207, internal context databases and session state file 210.

To personalize the conversation, access external dynamic data and/or fulfill a transaction, Interpreter 206 may access external data sources 213 and services 105 including:
External databases
Web services
Website pages through web servers
Email servers
Fax servers
Computer telephone integration (CTI) interfaces
Internet socket connections
Other Metaphor speech applications

FIG. 2 shows the steps taken by Interpreter 206 in more detail: The Application Interface 201 within communications interface 102 interfaces to Web server 203 within Application Server 202. The Web Server 203 first serves back to the communications interface 102 initialization steps for the dialog session application from the Initial Speech Interface File 204. Thereafter, Application Interface 201 calls Web Server 203 to begin the dialog session application loop through ASP file 205, which executes Interpreter 206 for each turn of conversation.

On a given turn of conversation, Interpreter 206 gets the text of what the user says (or types) from Application Interface 201 as well as a service script Application Project File 207 and current state data from Session State File 210. When Interpreter 206 completes the processing for one turn of conversation, it delivers that result back to Application Interface 201 through ASP file 205 and Web Server 203. The result is typically in a standard interface language such as VoiceXML or SALT. In the result, there may be references to Speech Grammar Files 208 and Audio Files 209 which are then fetched through Web Server 203. At this point, the voice gateway 102 plays audio for the user caller to hear the computer response message from a combination of audio files and text-to-speech and then the voice gateway 102 is prepared to recognize what the user will say next.

After Interpreter 206 returns the result, it saves the updated state data in Session State File 210 and may also log the results of that turn of conversation in Call Log File 211.

Within any turn of conversation there may also be calls to external Web Services 212 and/or external data sources 213 to personalize the conversation or fulfill the transaction. When the user speaks again, the entire Interpreter 206 loop is activated again to process the next turn of conversation.

On any given turn of conversation, Interpreter 206 will typically parse and interpret statements of script language and their associated properties in the script plan. Each of these statements may be either:
Dialog which specifies what to say to and what to recognize from the caller. The interpretation of a dialog statement will result in a VoiceXML, SALT or HTML output and control back to the voice gateway.
Flow control of the script that could contain conditional statements, loops or function calls or jumps. The interpretation will execute the specified flow control and then interpret the next statement.
External interface to a data source or data service to call control. The interpretation will execute the exchange with the external interface with the appropriate parameters, syntax and protocol. Then the next statement will be interpreted if there is a return process in place.
Internal state change. The interpretation will execute the changed state and then interpret the next statement.
If either an ‘exit’ or the final script statement is reached, the Interpreter will cause the voice gateway to hangup and end the processing of the application.

If call logging is enabled, Interpreter 206 will save conversation information about what was said by both the user and the virtual agent computer, what was recognized from the user, on which turn it occurred, and various descriptions and analyses of turns, call dialog sessions and applications.

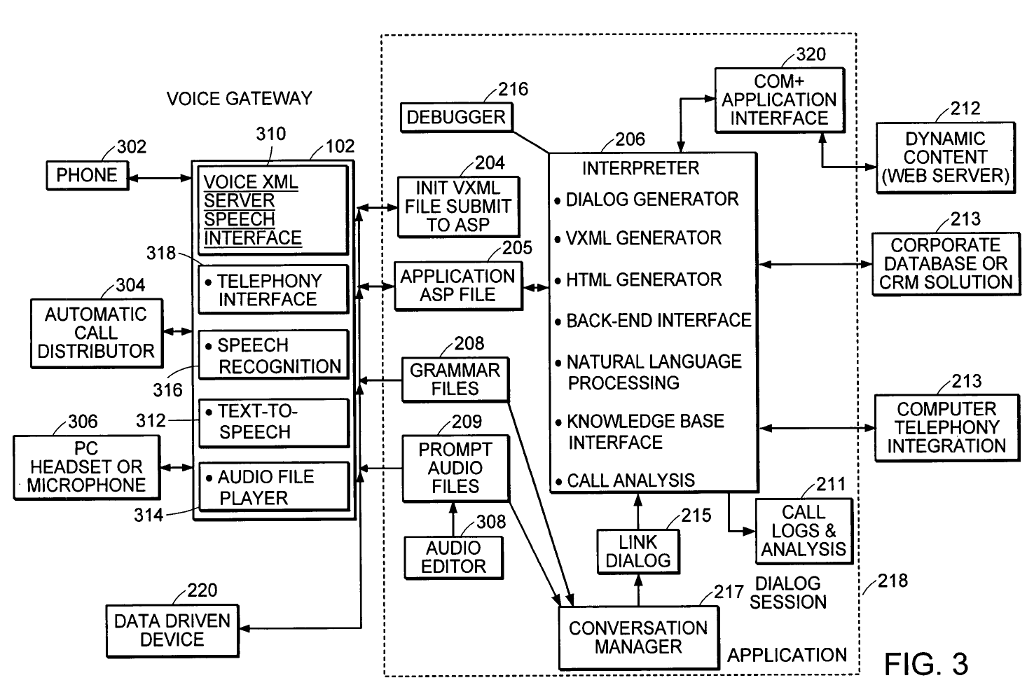

In another embodiment, as shown in FIG. 3, the dialog application 218, also referred to as a Conversation Manager (CM), operates in an integrated development environment (IDE) for developing automated speech applications that interact with caller users of phones 302, interact with data sources such as web server 212, CRM and Corporate Telephony Integration (CTI) units 213, PC headsets 306, and with live agents through Automated Call Distributors (ACDs) 304 in circumstances when the call is transferred. The CM 218 includes an editor 217, linker 215, debugger 300 and run-time interpreter 206 that dynamically generates voice gateway 102 scripts in Voice XML and SALT from the high-level design-scripting language described herein. The CM 218 may also include an audio editor 308 to modify audio files 209. The CM 218 may also provide an interface to a data driven device 220. The CM 218 is as easy to use as writing a flowchart with many inherited resources and modifiable properties that allows unprecedented speed in development. Features of CM 218 typically include:
An intuitive high level scripting tool that speech-interface designers and developers can use to create, test and deliver the speech applications in the fastest possible time.
Dialog design structure based on real conversations instead of a sequence of forms. This allows much easier control of process flow where there are context dependent decisions.
A built-in library of reusable dialog modules and a framework that encourages speech application teams to leverage developed business applications across multiple speech applications in the enterprise and share library components across business units or partners.
Runtime debugger 300 is available for text simulations of voice speech dialogs.
Handles many speech application exceptions automatically.
Allows call logging and call analysis.
Support for all speech recognition engines that work underneath an open-standard interface like Voice XML.
Connectors to JDBC and ODBC-capable databases, including Microsoft SQL Server, Oracle, IBM DB2, and Informix; and interfaces including COM+, Web services, Microsoft Exchange and ACD screen pops.

The CM 218 process flow for transactions either over the phone 302 or on a PC 306 are shown in the system diagram of FIG. 3.

The steps in the CM 218 run time process are:
1. User places a call to a speech application.
2. The communications interface 102, i.e., voice gateway, picks up the call and maps the phone number of the call to the initial Voice XML file 204.
3. The initial Voice XML file 204 submits an ASP call to the application ASP file 205.
4. The application ASP file 205 initializes administrative parameters and calls the CM 218.
5. The CM 218 interprets the scripts written in the present script language using interpreter 206. The script is an interpreted language that processes a series of dialog plans and process controls for interfacing to a user 100 (FIG. 1), databases 213, web and internal dialog context to achieve the joint goals of user 100 and virtual agent within CM 218. When the code processes a plan for a user 100 interface, it delivers the prompt, speech grammar files 208 and audio files 209 needed for one turn of conversation to a media gateway such as communications interface 102 for final exchange with user 100.
The CM typically generates Voice XML on the fly as it interprets the script code. It initializes itself and reads the first plan in the <start> script. This plan provides the first prompt and reference to any audio and speech recognition speech grammar files 208 for the user 100 interface. It formats the dialog interface into Voice XML and returns it to the Voice XML server 310 in the communications interface 102. The Voice XML server 310 processes the request through its audio file player 314 and text-to-speech player 312 if needed and then waits for the user to talk. When the user 100 is done speaking, his speech is recognized by the voice gateway 102 using the speech grammar provided and speech recognition unit 316. It is then submitted again to the application ASP file 205 in step 4. Steps 4 and 5 repeat for the entire dialog.
6. If CM 218 needs to get or set data externally it can interface to web services 212 and CTI or CRM solutions and databases 213 either directly or through custom COM+ data interface 320.
7. An ODBC interface can be used from the CM 218 script language directly to any popular database.
8. If call logging is enabled, the user audio, dialog prompts used may be stored in database 211 and the call statistics for the application are incremented during a session. Detail and summary call analyses may also be stored in database 211 for generating customer reports.

Implementations of conversations are extremely fast to develop because the developer never writes any Voice XML or SALT code and many exceptions in the conversations are handled automatically. An HTML debugger is also available for the script language.

It will be apparent to those of ordinary skill in the art that methods involved in the present invention may be embodied in a computer program product that includes a computer readable and usable medium. For example, such a computer usable medium may consist of a read only memory device, such as a CD ROM disk or conventional ROM devices, or a random access memory, such as a hard drive device or a computer diskette, having a computer readable program code stored thereon.

While this invention has been particularly shown and described with references to preferred embodiments thereof, it will be understood by those skilled in the art that various changes in form and details may be made therein without departing from the scope of the invention encompassed by the appended claims.

1. A speech dialog management system, each dialog capable of supporting one or more turns of conversation between a user and virtual agent using any one or combination of a communications interface and data interface, the system comprising:
a computer;
a computer readable medium, operatively coupled to the computer, storing scripts and dialog information, each script determining the recognition, response, and flow control in a dialog, each script further inheriting speech dialog resources; and
an application running on the computer that, based on the dialog information and user input, delivers a result to any one or combination of the communications interface and data interface.

2. The system according to claim 1 wherein the scripts are defined using a script language, the script language including any one or combination of literals, integers, floating-point literals, Boolean literals, dialog variables, internal dialog variables, arrays, operators, functions, if/then statements, switch/case statements, loops, for loops, while loops, do/while loops, dialog statements, external interfaces statements, and special statements.

3. The system according to claim 1 wherein the communications interface, based on the result, delivers a message to the user.

4. The system according to claim 1 wherein the dialog information includes any one or combination of dialog prompts, audio files, speech grammars, external interface references, one or more scripts, and script variables.

5. The system according to claim 1 wherein the result is further based on any one or combination of external sources including external databases, web services, web pages through web servers, e-mail servers, fax servers, CTI interfaces, Internet socket connections, and other dialog applications.

6. The system according to claim 1 wherein the result is further based on a dialog session state that determines where in a script to process a dialog next, the application saving a dialog session state after returning a result to any one or combination of the communications interface and data interface.

7. The system according to claim 1 further comprising:
an editor for entering scripts and dialog information into a project file, the project file being associated with a particular dialog; and
a linker that uses a project configuration in the project file to set up the implementation of a run-time environment for an associated dialog.

8. The system according to claim 1 further comprising a debugger that performs any one or combination of text simulations and debugging of speech dialogs.

9. The system according to claim 1 wherein the dialog includes any one or combination of flow control, context management, call management, dynamic speech grammar generation, communication with service agents, data transaction management and fulfillment management.

10. A computer method for managing speech dialogs, each dialog capable of supporting one or more turns of conversation between a user and virtual agent using any one or combination of a communications interface and data interface, the method comprising:
storing scripts and dialog information in a computer readable medium, operatively coupled to a computer, each script determining the recognition, response, and flow control in a dialog, each script further inheriting speech dialog resources; and
delivering a result to any one or combination of the communications interface and data interface from an application running on the computer based on the dialog information and user input.

11. The method according to claim 10 wherein the scripts are defined using a script language, the script language including any one or combination of literals, integers, floating-point literals, Boolean literals, dialog variables, internal dialog variables, arrays, operators, functions, if/then statements, switch/case statements, loops, for loops, while loops, do/while loops, dialog statements, external interfaces statements, and special statements.

12. The method according to claim 10 wherein the communications interface, based on the result, delivers a message to the user.

13. The method according to claim 10 wherein the dialog information includes any one or combination of dialog prompts, audio files, speech grammars, external interface references, one or more scripts, and script variables.

14. The method according to claim 10 wherein the result is further based on any one or combination of external sources including external databases, web services, web pages through web servers, e-mail servers, fax servers, CTI interfaces, Internet socket connections, and other dialog applications.

15. The method according to claim 10 wherein the result is further based on a dialog session state that determines where in a script to process a dialog next, the application saving a dialog session state after returning a result to any one or combination of the communications interface and data interface.

16. The method according to claim 10 further comprising:
entering scripts and dialog information into a project file using an editor, the project file being associated with a particular dialog; and
setting up the implementation of a run-time environment for an associated dialog using a linker based on a project configuration in the project file.

17. The method according to claim 10 further comprising using a debugger that performs any one or combination of text simulations and debugging of speech dialogs.

18. The method according to claim 10 wherein the dialog includes any one or combination of flow control, context management, call management, dynamic speech grammar generation, communication with service agents, data transaction management and fulfillment management.

19. A computer readable medium having computer readable program codes embodied therein for managing speech dialogs, each dialog capable of supporting one or more turns of conversation between a user and virtual agent using any one or combination of a communications interface and data interface, the computer readable medium program codes performing functions comprising:
storing scripts and dialog information, each script determining the recognition, response, and flow control in a dialog, each script further inheriting speech dialog resources; and
delivering a result to any one or combination of the communications interface and data interface based on the dialog information and user input.

20. The computer readable medium according to claim 19 wherein the scripts are defined using a script language, the script language including any one or combination of literals, integers, floating-point literals, Boolean literals, dialog variables, internal dialog variables, arrays, operators, functions, if/then statements, switch/case statements, loops, for loops, while loops, do/while loops, dialog statements, external interfaces statements, and special statements.

21. The computer readable medium according to claim 19 wherein the communications interface, based on the result, delivers a message to the user.

22. The computer readable medium according to claim 19 wherein the dialog information includes any one or combination of dialog prompts, audio files, speech grammars, external interface references, one or more scripts, and script variables.

23. The computer readable medium according to claim 19 wherein the result is further based on any one or combination of external sources including external databases, web services, web pages through web servers, e-mail servers, fax servers, CTI interfaces, Internet socket connections, and other dialog applications.

24. The computer readable medium according to claim 19 wherein the result is further based on a dialog session state that determines where in a script to process a dialog next, the application saving a dialog session state after returning a result to any one or combination of the communications interface and data interface.

25. The computer readable medium according to claim 19 further comprising functions performing:
entering scripts and dialog information into a project file using an editor, the project file being associated with a particular dialog; and
setting up the implementation of a run-time environment for an associated dialog using a linker based on a project configuration in the project file.

26. The computer readable medium according to claim 19 further comprising using a debugger that performs any one or combination of text simulations and debugging of speech dialogs.

27. The computer readable medium according to claim 19 wherein the dialog includes any one or combination of flow control, context management, call management, dynamic speech grammar generation, communication with service agents, data transaction management and fulfillment management.

28. The system according to claim 1 wherein the application includes a run-time interpreter that processes one or more of the scripts for a user interface to deliver the result.

29. The method according to claim 10 wherein the application includes a run-time interpreter that processes one or more of the scripts for a user interface to deliver the result.

30. The computer readable medium according to claim 19 wherein a run-time interpreter processes one or more of the scripts for a user interface to deliver the result.
